(19) United States
(12) Patent Application Publication
(10) Pub. No.: US 2023/0303218 A1
(43) Pub. Date: Sep. 28, 2023

(54) A DEVICE FOR ATTACHING A STANCHION TO A HULL OF A BOAT

(71) Applicant: Lucio FILIPPELLI, LA SPEZIA (IT)

(72) Inventor: Lucio FILIPPELLI, LA SPEZIA (IT)

(21) Appl. No.: 18/042,269

(22) PCT Filed: Aug. 31, 2021
(86) PCT No.: PCT/IB2021/057925

§ 371 Date: Feb. 20, 2023

(30) Foreign Application Priority Data
Sep. 2, 2020 (IT) 1020200000854

(51) Int. Cl. B63B 17/04; F16B 47/00

(52) U.S. Cl. CPC B63B 17/04; F16B 47/00

(57) ABSTRACT

A device for attaching a stanchion to a boat hull including a first arm defining a first direction of extension, a first constraint connected to the first arm and defining at least a first constraint surface to arrange in contact with a part of the hull, a second arm connected to the first arm and defining a second direction of extension transversal with respect to the first extension direction, and a second constraint connected to the second arm and defining at least a second constraint surface to contact a part of the hull. The constraints are configured to integrally constrain the device to the hull so that, when the stanchion is constrained to, or part of, one or more chosen among the arms, the stanchion is bound to the hull.

The present invention relates to a device for attaching a stanchion to a hull of a boat of the type specified in the preamble of the first claim.

In particular, the present invention relates to an attachment device configured to be coupled to any area of a hull, such as the hood, the gunwale or even the stern platform, for example in order to provide a removable guardrail.

As is known, almost all small or medium-sized boats include a guardrail, that is a perimetric portion of the boat in correspondence with which metal poles, called stanchions, connected by one or more metal cables placed under tension, called runners.

Generally, the runners connect the stanchions at least at their ends and, in addition, at one or more intermediate points arranged along the extension of the stanchions themselves.

Furthermore, the stanchions are usually constrained to the edges of the hull by means of resolvable constraints such as, for example, bolting or other similar means of constraint.

In traditional configurations, the edges of the hull may have resin, glass or steel parapets which almost never reach a sufficient height to guarantee adequate safety. Alternatively, the edges of the hull have cavities inside which at least part of the base of the stanchions themselves is housed. Alternatively, the stanchions are inserted, being usually hollow at the low end, in a pin of variable material, for example metal, resins or carbon, which protrudes at the edge defined by the boat's gunwale for a length between 15-25 cm. The stanchions inserted on the pin are then locked to the pin itself with a common grain.

The guardrail thus made substantially defines a support bulkhead for the users on board in such a way as to increase their safety and prevent people, or even objects on board the boat from being easily thrown from it, in navigation phase, without any obstacles.

However, not all boats are designed to accommodate the stanchions as described above. Motorboats, for example, are rarely designed to house stanchions along the perimeter of the hull.

Therefore, the constraint systems of the stanchions of the known art are not suitable for any boat.

However, some attachment devices described in U.S. Pat. No. 6,607,054 and EP-A-2415501 are known.

These applications describe devices comprising a plurality of tubular elements each equipped with a sucker system configured to allow the connection, on command, with a hooking surface in such a way as to form a railing such as, for example, a guardrail.

In particular, the document U.S. Pat. No. 6,607,054 describes the use of such devices also on transport means such as airplanes or boats, while the document EP-A-2415501 describes, in detail, a device with particular flexibility in order to allow the adaptation of the railing to any type of surface.

The known art described includes some important drawbacks.

In particular, the devices do not allow to obtain a sufficient degree of safety since they are based entirely on the resistance of the constraint defined by the sucker. When the sucker devices are subjected to high loads they can, in fact, risk detachment with consequent localized failure of the device.

In addition, in any case, the constraint does not provide for any redundancy and if unwanted breakages or detachments of the suckers occur, the device becomes absolutely unsafe and indeed very dangerous since, at least in appearance, the railing can be entirely intact.

In this situation, the technical task underlying the present invention is to devise a device for attaching a stanchion to a hull of a boat capable of substantially obviating at least part of the aforementioned drawbacks.

Within the scope of said technical task, it is an important object of the invention to obtain a device for attaching a stanchion to a hull of a boat which is extremely resistant.

In particular, moreover, a further object of the invention is to provide an attachment device which introduces redundancies such as to always maintain a high degree of safety.

Another important object of the invention is to provide an attachment device which is versatile and which, in the face of the same structure, can be efficiently attached to any part of a hull of a boat, for example on a hood, a gunwale, a stern platform or other parts.

The technical task and the specified aims are achieved by a device for attaching a stanchion to a hull of a boat as claimed in the annexed claim 1.

Preferred technical solutions are highlighted in the dependent claims.

The characteristics and advantages of the invention are clarified below by the detailed description of preferred embodiments of the invention, with reference to the accompanying figures, in which:

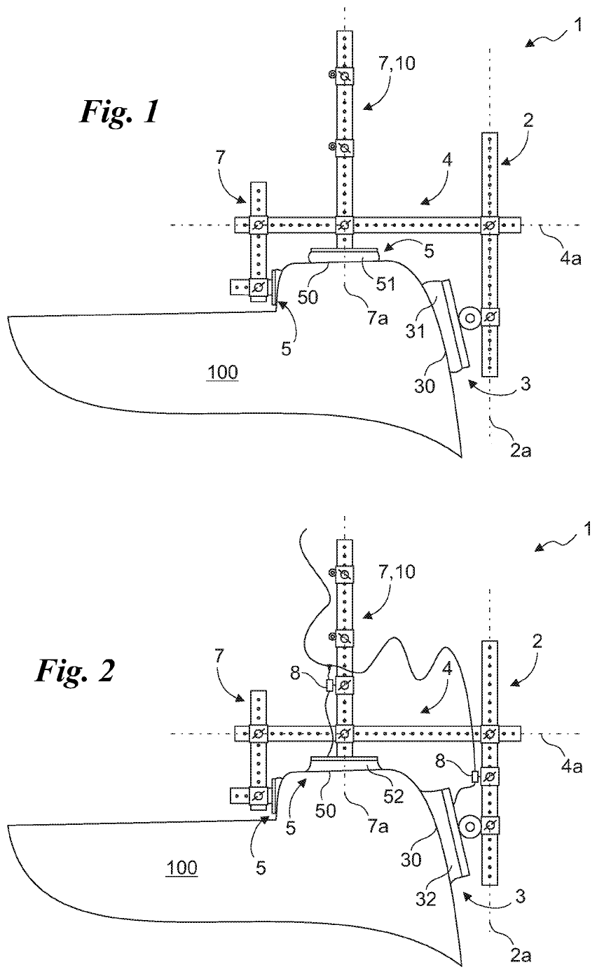

the FIG. 1 shows a device for attaching a stanchion to a hull of a boat according to the invention in a first embodiment;

the FIG. 2 illustrates a device for attaching a stanchion to a hull of a boat according to the invention in a second embodiment;

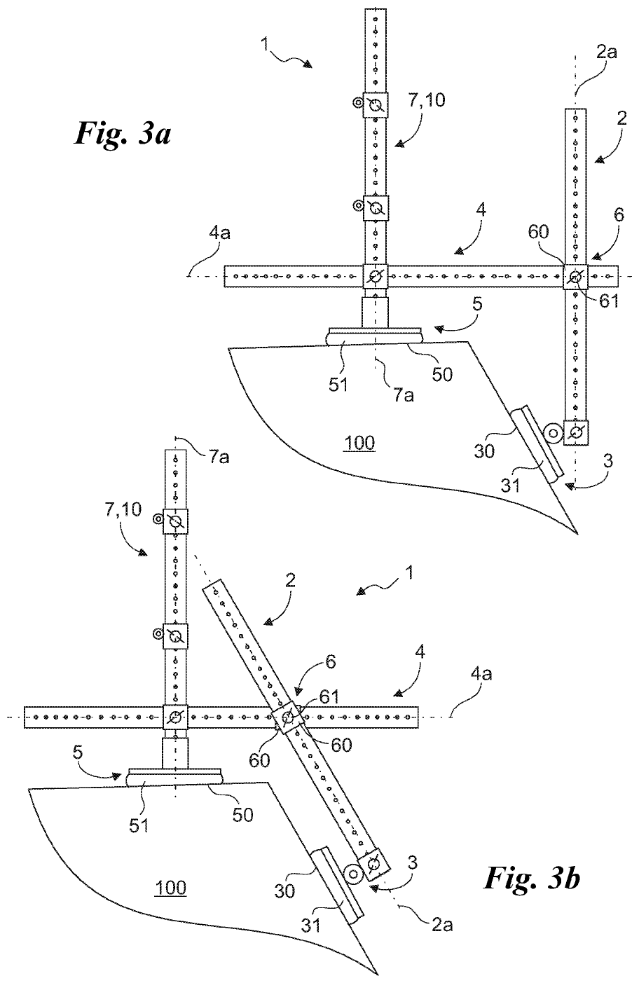

the FIG. 3a is a device for attaching a stanchion to a hull of a boat according to the invention in a third embodiment wherein the arms are mutually perpendicular;

the FIG. 3b shows the device of FIG. 3a wherein the arms are rotated to each other in such a way that one of the arms is parallel to the hull of a boat;

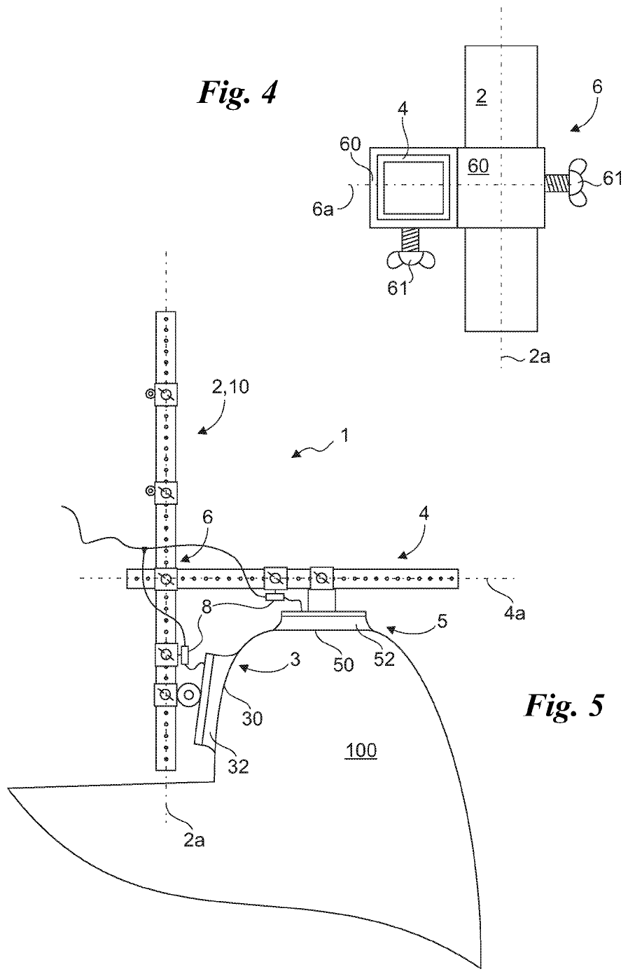

the FIG. 4 shows the detail of the connecting means for the arms of a device for attacking a stanchion to a hull of a boat according to the invention;

the FIG. 5 illustrates a device for attacking a stanchion to a hull of a boat according to the invention in a fourth embodiment;

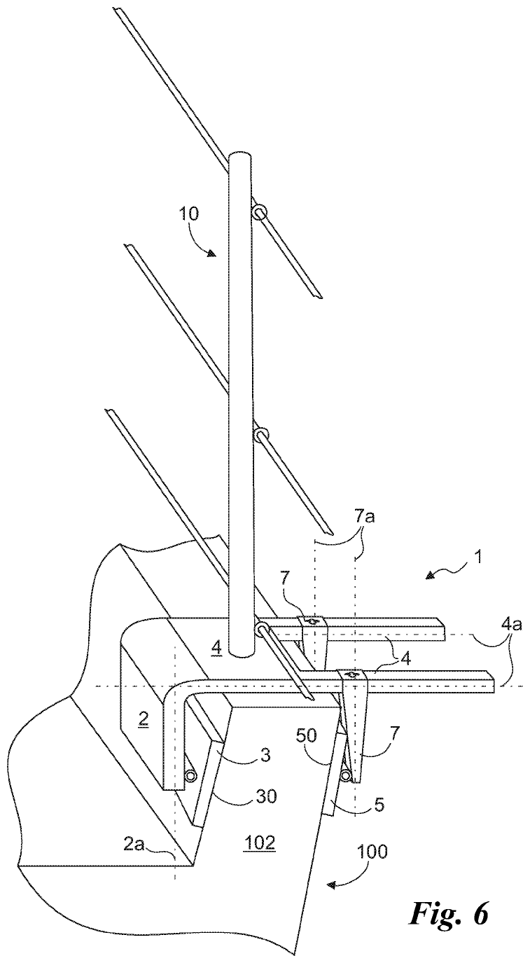

the FIG. 6 is a device for attacking a stanchion to a hull of a boat according to the invention in an alternative embodiment wherein the arms are in one piece and the device is installed on a gunwale;

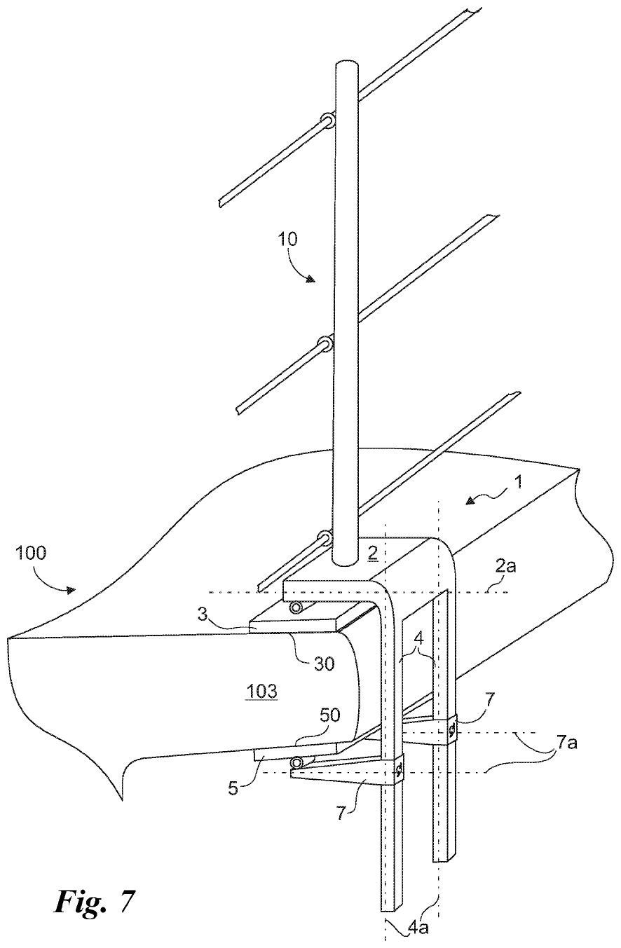

the FIG. 7 represents the device of FIG. 6 installed on a stern platform;

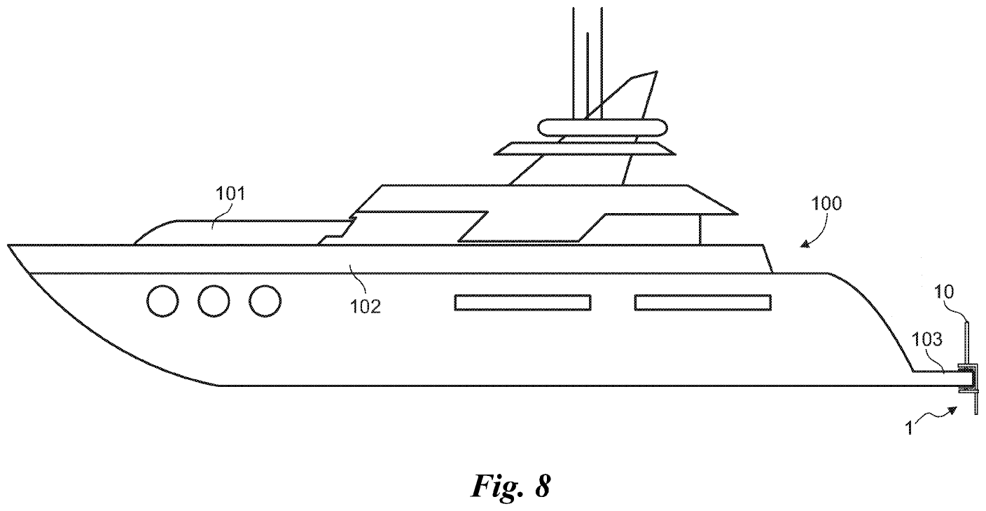

the FIG. 8 shows a boat on which a device for attaching a stanchion to a hull of a boat is installed according to the invention;

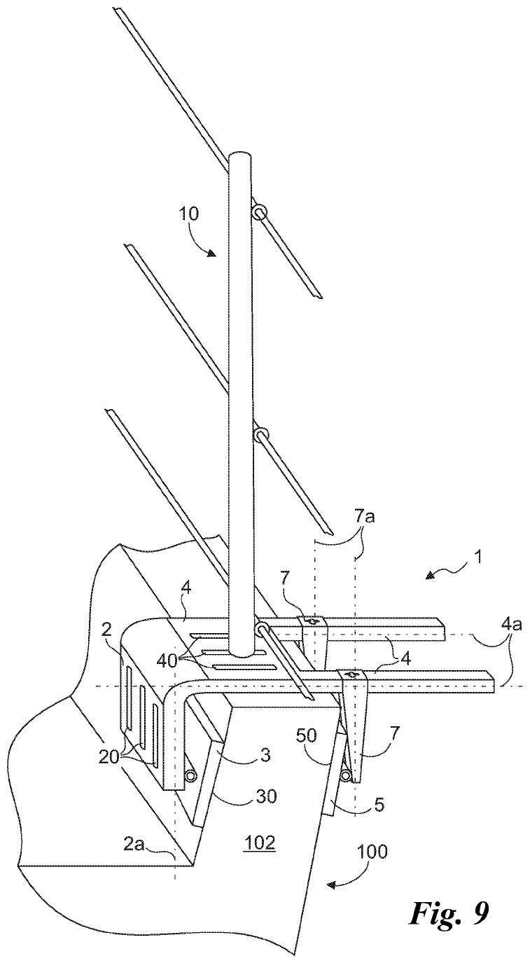

the FIG. 9 illustrates a device for attaching a stanchion to a hull of a boat according to the invention in an alternative embodiment wherein the arms include the seats to allow the controlled positioning of the stanchion;

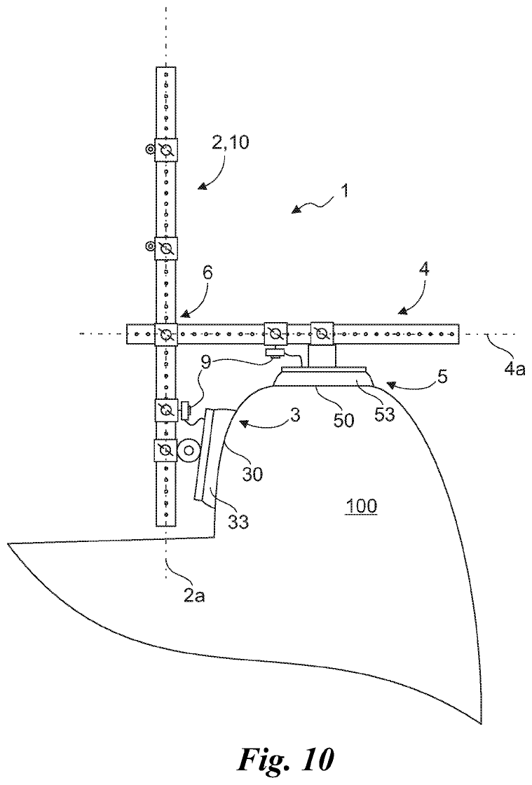

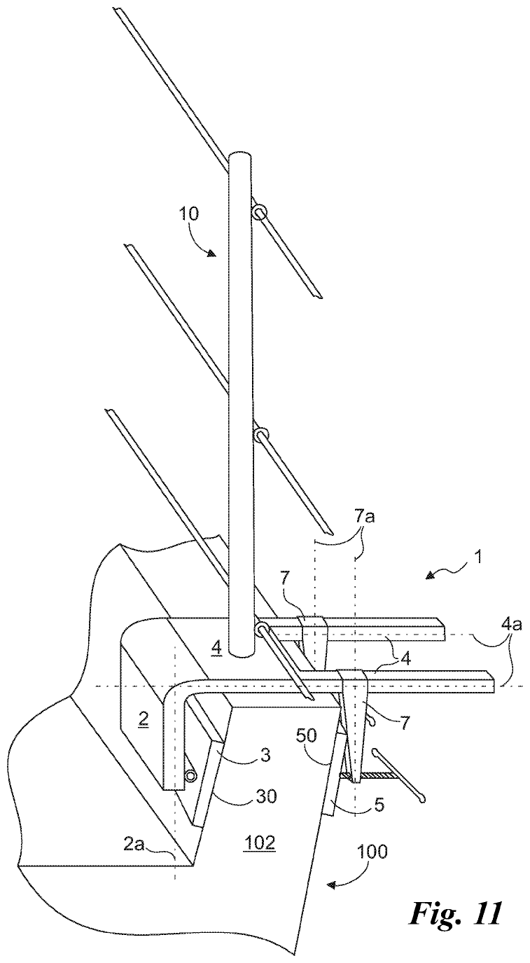

the FIG. 10 is a device for attaching a stanchion to a hull of a boat according to the invention in a fifth embodiment wherein the constraint means include controllable electromagnetic elements by means of control means; and

the FIG. 11 represents device for attaching a stanchion to a hull of a boat according to the invention wherein the second constraint means are rigidly constrained to the third arm by means of crank devices so they can be shifted along a direction perpendicular to the third direction of extension.

In the present document, the measurements, values, shapes and geometric references (such as perpendicularity and parallelism), when associated with words like “about” or other similar terms such as “approximately” or “substantially”, are to be considered as except for measurement errors or inaccuracies due to production and/or manufacturing errors, and, above all, except for a slight divergence from the value, measurements, shape, or geometric reference with which it is associated. For instance, these terms, if associated with a value, preferably indicate a divergence of not more than 10% of the value.

Moreover, when used, terms such as “first”, “second”, “higher”, “lower”, “main” and “secondary” do not necessarily identify an order, a priority of relationship or a relative position, but can simply be used to clearly distinguish between their different components.

Unless otherwise specified, as results in the following discussions, terms such as “treatment”, “computing”, “determination”, “calculation”, or similar, refer to the action and/or processes of a computer or similar electronic calculation device that manipulates and/or transforms data represented as physical, such as electronic quantities of registers of a computer system and/or memories in, other data similarly represented as physical quantities within computer systems, registers or other storage, transmission or information displaying devices.

The measurements and data reported in this text are to be considered, unless otherwise indicated, as performed in the International Standard Atmosphere ICAO (ISO 2533:1975).

With reference to the Figures, the device for attaching a stanchion to a hull of a boat according to the invention is globally indicated with the number 1.

The device 1 is adapted to be installed on any boat. For example, the boat can be of the sail type, or it can also be motorized, for example a motorboat, or similar.

In particular, the device 1 is adapted to attached to a part of the hull 100.

The hull 100, as known, is the structure of the boat to which the buoyancy is entrusted. It usually appears as a solid whose longitudinal dimension is preponderant with respect to the others: the width is usually greater in the central area and therefore decreases at the ends.

The hull 100 therefore generally defines two interconnected lateral bulkheads which delimit the boat.

Furthermore, the hull 100 can determine the presence, or not, of some particular elements typical of boats. The hull 100 can comprise a hood 101 and/or one or more gunwales 102 and/or one or more stern platform 103.

The hood 101 is an upper portion of the hull 100 which can be configured to cover a portion of the boat.

The gunwale 102 is substantially a side or edge defined by the upper ends of the hull and which perimetrically delimits the walkable area of the boat.

The stern platform 103 or bathing bridge is instead a platform, generally arranged in the stern area of the boat, mainly adapted to facilitate entry and exit from the water since it is often located close to the free surface of the latter.

The device 1 is also configured to allow one or more stanchions 10 to be attached onto the hull 100.

The stanchions 10 are substantially stakes, tubular or solid, constrained in correspondence with the perimeter areas of the boats, for example on the arms 102. Substantially, therefore, the stanchions 10 are elements protruding from the edge or arranged on the edge itself in an orderly manner.

Overall, the stanchions 10 can form a guardrail. The guardrails known in the current state of the art are barriers, usually with a maximum height of 90 cm, which limit the possibility for users to be thrown out of the boat.

In order to make a guardrail, the stanchions 10 are preferably provided with slots, along their extension, suitable for allowing the passage of runners. The runners consist of high-strength cables which generally connect the stanchions 10 of the railing in succession. Each runner is usually tensioned and may include steel material.

Furthermore, the runner is usually housed in slots arranged at the free end of the stanchions 10, but it could equally well be placed in other points of the extension of the stanchion 10, as already mentioned. The guardrail can therefore include one or more runners extending continuously between one stanchion 10 and the other, but placed along different points of the extension of the stanchions 10.

Usually, in substance, the runners are parallel cables linked together in succession to the stanchions 10 in such a way as to be perpendicular to them, so that the guardrail substantially defines a railing or balustrade for the boat.

The device 1 can also include the stanchion 10 or can be configured to allow the constraint of a stanchion 10 on itself.

In any case, the device 1 essentially comprises at least a first arm 2.

The first arm 2 can be a rod or a plate or a tubular element, for example a hollow beam.

The first arm 2 therefore defines at least a first extension direction 2a.

The first extension direction 2a is the direction along which the first arm 2 expands predominantly.

The first arm 2, preferably but not necessarily, is a tubular element comprising a plurality of holes arranged along the first extension direction 2a.

Furthermore, these holes can be ordered in one row, or they can be ordered in several rows. They can, therefore, be distributed in an orderly manner along the extension direction 2a and along their own row.

If the first arm 2 is a hollow beam with a square base, the holes can be distributed in four rows each arranged along the sides of the beam extending along the extension direction 2a.

Furthermore, the holes can be through or non-through. If not passing through, the holes are arranged in such a way as to allow the creation of a first airtight arm 2 which can define an air reservoir.

The device 1 also comprises first constraint means 3.

The first constraint means 3 are substantially elements which allow the constraint, suitably integral, between the device 1 and the hull 100. The constraint is preferably solvable.

The first constraint means 3 are therefore connected to the first arm 2.

Even more in detail, preferably, the first constraint means 3 are constrained in a compliant way to the first arm 2.

In particular, the first constraint means 3 can be constraint in a compliant way to the first arm 2 in such a way as to be rotatable, with respect to it, about at least one axis. For example, the constraint can be made with a mechanical hinge having an axis oriented perpendicular to the first extension direction 2a.

Alternatively, the constraint can be even more compliant and allow the reciprocal rotation of the first constraint means 3 with respect to the first arm 2 with respect to several axes. In this sense, for example, the constraint can be made with a spherical hinge.

Or else, deformable connection elements, for example elastomeric, can be provided and the relative rotations between the first constraint means 3 and the first arm 2 can be realized by elastically deformable structures, possibly even partially plastically, for example of the bearingless type.

The first constraint means 3 therefore define a first constraint surface 30.

The first constraint surface 30 is substantially a part of the first constraint means 3 configured to be arranged in contact with a part of the hull 100.

Preferably, the first constraint surface 30 is inclinable with respect to the first extension direction 2a. In particular, it can be tilted thanks to the constraint elements as previously discussed, such as the mechanical hinges or other similar elements.

Furthermore, the first constraint surface 30 can be made in different ways.

For example, it can be made from a first membrane 31. Therefore, the first constraint means 3 can comprise the first membrane 31.

The first membrane 31, if present, is preferably elastomeric. Therefore, the first membrane 31 is able to come into contact with the hull 100 causing sufficient friction and avoiding wearing out, for example scratching, the hull 100.

Naturally, the constraint surface 30 could also be made from a solid element, possibly metallic and possibly defining knurls to increase the friction between the first constraint means 3 and the hull 100. However, at least to preserve the aesthetics of the original hull 100, it is preferable that the constraint surface 30 is made of a softer element, or in any case deformable, like the first membrane 31.

Alternatively, the first constraint surface 30 can be made from the edges of a first sucker 32.

Therefore, the first constraint means 3 can comprise the first sucker 32.

The first constraint surface 30 therefore appears as a flat ring determined by the perimeter bulkheads of the first sucker 32.

The first sucker 32 can, therefore, be of the type manual and able to be constrained to the hull 100 when placed under pressure, from the outside, in such a way as to lock onto the hull 100 itself.

Alternatively, the first sucker 32 can be controlled by external elements and/or can also provide control elements such as valves or similar.

Preferably, the device 1 equipped with a first suction cup 32 comprises pressurization means 8.

The pressurizing means 8 are preferably operatively connected to the first sucker 32. In particular, they are configured to depressurize on command a space between the sucker 32 and the hull in such a way as to block the sucker 32 on the hull 100.

Pressurizing means 8 suitable can be, for example, common pumps substantially adapted to remove air from the space trapped between the suction cup 32 and the hull 100 and to create the vacuum between them.

The pressurizing means 8 can also comprise part of the first arm 2, for example when the latter acts as an air tank. The pressurizing means 8 could in fact be able to let the air present in the space between the first sucker 32 and the hull 100 flow out and make it flow inside the first arm 2. In this case, the pressurizing means 8 would be substantially integrated in the device 1.

In addition, the first constraint means 3 can include at least a first electromagnetic element 33.

The first electromagnetic element 33 can be, for example, an electromagnet. Even more in detail, the first electromagnetic element 33 can be an electromagnet externally coated with a deformable film in such a way as to allow easy adaptation of the electromagnetic element to any surface.

In this case, the first constraint surface 30 can therefore be defined by the surface of the magnet or by the surface of the film.

In particular, the first electromagnetic element 33 can be a device which can be activated electronically, on command, in such a way as to generate an attractive magnetic field capable of allowing the constraint, by means of the magnetic attraction force generated, between the device 1, in particular the first constraint means 3, and the hull 100.

Therefore, the device 1 could also include control means 9.

The control means 9 are preferably operatively connected to the first electromagnetic element 33. Furthermore, they are configured to allow the control of the first electromagnetic element 33.

Therefore, the control means can be electronic control means, with autonomous power supply, by means of a battery, or not autonomous, that is, for example external by means of wiring, suitable to allow the actuation, by command of the first electromagnetic element 33.

The control means 9 can also include a simple switch, operable from the outside of the device 1, able to allow the generation of magnetic force to lock the first fastening means 3 on the hull 100.

The magnetic force is substantially a mutual attraction force between the first electromagnetic element 53 and the hull 100.

Furthermore, the control means 9 could include one or more batteries and the latter could be housed within at least the first arm 2.

Advantageously, the device 1 also includes a second arm 4.

The second arm 4 is preferably similar or of the same type as the first arm 2. It can also be identical to the first arm 2.

The second arm 4 can, therefore, also be a rod or a plate or a tubular element, for example a hollow beam.

The second arm 4 therefore defines at least a second extension direction 4a.

The second extension direction 4a is the direction along which the second arm 4 develops predominantly.

Preferably, the second extension direction 4a is transverse, in at least one configuration of use, with respect to the first extension direction 2a. The second extension direction 4a can be, in detail, perpendicular or simply incident or skewed with respect to the first extension direction 2a.

The fact that the second extension direction 4a is transverse to the first extension direction 2a in at least one configuration of use does not imply that the second extension direction 4a and the first extension direction 2a cannot be parallel to each other.

The second arm 4, preferably but not necessarily, is a tubular element comprising a plurality of holes arranged along the second extension direction 4a.

Furthermore, these holes can be ordered in one row, or they can be ordered in several rows. They can, therefore, be distributed in an orderly manner along the second direction of extension 4a and along their own row.

If the second arm 4 is a hollow beam with a square base, the holes can be distributed in four rows each arranged along the sides of the beam extending along the second extension direction 4a.

These holes can also be through or non-through. If not passing through, the holes are arranged in such a way as to allow the creation of a second airtight arm 4 which can define an air tank.

In particular, preferably, the second arm 4 is connected to the first arm 2.

Even more in detail, the second arm 4 and the first arm 2 are preferably mutually constrained by connection means 6.

The connection means 6 are configured to constrain in a compliant way the first arm 2 and the second arm 4 in such a way that the directions of extension 2a, 4a are mutually skewed and the arms 2, 4 are mutually rotatable.

In other words, the connection means 6 allow to determine the mutual orientation between the extension directions 2a, 4a.

Such connection means 6 may include, for example, a pair of sliders 60.

The sliders 60 can be annular elements able to be fitted on the first arm 2 and on the second arm 4.

The sliders 60 can therefore be counter-shaped to the arms 2, 4. Furthermore, the sliders 60 are mutually connected by connection means. For example, the connection can be a mechanical hinge. Optionally, the connector can include a toothed wheel adapted to allow snap adjustment of the mutual orientation of the two sliders 60.

In any case, the sliders 60 are mutually rotatable with respect to a rotation axis 6a. The rotation axis 6a is preferably perpendicular to both extension directions 2a, 4a. The rotation axis 6a allows the sliders 60 to rotate reciprocally in such a way that the mutual orientation between the extension directions 2a, 4a can be varied.

The connector, of course, defines the rotation axis 6a.

Each slider 60 can also be locked on the respective arm 2, 4 by means of coupling means 61.

The coupling means 61 can be simple threaded screws that can be controlled from the outside and adapted to exploit holes arranged on the sliders 60 themselves and on the arms 2, 4.

Naturally, other coupling means 61 could be used, such as a lining inside the cursors and suitable for to locally increase the friction between arm 2, 4 and slider 60. Such means are, however, well known in the current state of the art.

The connection means 6, as a whole, could also be replaced by any equivalent means simply adapted to allow the connection of two elongated elements, such as the arms 2, 4, and their reciprocal rotation on command.

In simplified embodiments of the device 1, the connection means 6 could also be non-compliant. Therefore, a kit of different connection means 6 could be realized to allow the coupling of the arms 2, 4 with different inclinations of the extension directions 2a, 4a.

Advantageously, in any case, the device 1 further comprises second constraint means 5.

The second constraint means 5 are connected to the second arm 4.

In this sense they can be directly connected, that is constrained, to the second arm 4 or they could be indirectly connected to the second arm 4 as better specified hereinafter.

In fact, the device 1 could also comprise a third arm 7.

The third arm 7, if present, can be similar or of the same type as the arms 2, 4. It can also be identical to the arms 2, 4.

Also the third arm 7 can, therefore, be a rod or a plate or a tubular element, for example a hollow beam.

The third arm 7 therefore defines at least a third extension direction 7a.

The third direction of extension 7a is the direction along which the third arm 7 expands predominantly.

Preferably, the third extension direction 7a is transverse, in at least one configuration of use, with respect to the second extension direction 4a. The third extension direction 7a can be, in detail, perpendicular or simply incident or skewed with respect to the second extension direction 4a.

The fact that the third extension direction 7a is transverse to the second extension direction 4a in at least one configuration of use does not imply that the third extension direction 7a and the second extension direction 4a cannot be parallel to each other.

The third arm 7, preferably but not necessarily, is a tubular element comprising a plurality of holes arranged along the second extension direction 7a.

Furthermore, these holes can be ordered in one row, or they can be ordered in several rows. They can, therefore, be distributed in an orderly manner along the third extension direction 7a and along their own row.

If the third arm 7 is a hollow beam with a square base, as shown in FIGS. 1-3b, the holes can be distributed in four rows each arranged along the sides of the beam extending along the third direction of extension 7a.

Furthermore, the holes can be through or through. If not passing through, the holes are arranged in such a way as to allow the creation of a third airtight arm 7 which can define an air tank.

The third arm 7 can also be a simple connector, for example a bar, as shown in FIGS. 6-7, adapted to connect the second constraint means 5 with the second arm 4.

Preferably, if present, the third arm 7 is configured to mutually connect the second arm 4 and the second constraint means 5.

The third arm 7 can moreover, be constrained in a compliant way to the second arm 4 in such a way that it can be rotated with respect to it or be fixed.

In addition, the third arm 7 can be constrained in a compliant way to the second arm 4 in such a way as to be able to translate on command along the second extension direction 4a.

The second constraint means 5 are substantially similar to the first fastening means 3. They can, therefore, adopt the different configurations previously described.

The second constraint means 5 are therefore substantially elements which allow the constraint, suitably integral, between the device 1 and the hull 100. Preferably the constraint can be resolved.

The second constraint means 5 can be constraint in a compliant way to the second arm 4. Or, preferably, they can be constrained in a compliant way to the third arm 7. In this way, the second constraint means 5 can be rotated, with respect to the second arm 4 or to the third arm 7, around at least one axis. For example, the constraint can be made with a mechanical hinge having an axis oriented perpendicular to the second extension direction 4a and/or third extension direction 7a.

Alternatively, the constraint can be even more compliant and allow the reciprocal rotation of the second constraint means 5 with respect to the second arm 4 or to the third arm 7 with respect to several axes. In this sense, for example, the constraint can be made with a spherical hinge.

Or else, deformable connection elements, for example elastomeric, can be provided and the relative rotations between second constraint means 5 and second arm 4 or third arm 7 can be made from elastically deformable structures, possibly even partially plastically, for example of the bearingless type.

The second constraint means 5 therefore define a second constraint surface 50.

The second constraint surface 50 is substantially a part of the second constraint means 5 configured to be arranged in contact with a part of the hull 100.

Preferably, the second constraint surface 50 is inclinable with respect to the second direction of extension 4a or to the third extension direction 7a depending on how the connection between the second constraint means 5 and the second arm 4 is made. In particular, it can be tilted thanks to the constraint elements as discussed above, such as mechanical hinges or other similar elements.

Moreover, also the second constraint surface 50 can be realized in different ways. For example, it can be made from a second membrane 51. Therefore, the second constraint means 5 can comprise the second membrane 51.

The second membrane 51, if present, is preferably elastomeric. Therefore, the second membrane 51 is able to come into contact with the hull 100 causing sufficient friction and avoiding wearing out, for example scratching, the hull 100.

Naturally, the second constraint surface 50 could also be made from a solid element, possibly metallic and possibly defining knurls to increase the friction between second constraint means 5 and hull 100. However, at least to preserve the aesthetics of the original hull 100, it is preferable that the second constraining surface 50 is made from an element softer, or in any case deformable, like the second membrane 51.

Alternatively, the second constraint surface 50 can be made from the edges of a second sucker 52.

Therefore, the second constraint means 5 can comprise the second sucker 52.

The second constraint surface 50 therefore appears as a flat ring determined by the perimeter bulkheads of the second sucker 52.

The second sucker 52 can, therefore, be of the type manual and able to be constrained to the hull 100 when placed under pressure, from the outside, in such a way as to lock onto the hull 100 itself.

Alternatively, the second sucker 32 can be controlled by external elements and/or can also provide control elements such as valves or similar.

Preferably, the device 1 equipped with the second sucker 52, also comprises the pressurizing means 8.

The pressurizing means 8 can be operatively connected also, or only, to the second sucker 52. In particular, they are configured to depressurize a space on command comprised between the second sucker 52 and the hull 100 in such a way as to block the second sucker 52 on the hull 100.

The pressurizing means 8 can also comprise part of the second arm 4, for example when the latter acts as an air tank. The pressurizing means 8 could in fact be adapted to let the air present in the space between the second sucker 52 and the hull 100 flow out and make it flow into the second arm 4. In this case, the pressurizing means 8 would be substantially integrated in the device 1.

The second constraint means 5 can also include at least a second electromagnetic element 53.

The second electromagnetic element 53 can be, for example, an electromagnet. Even more in detail, the second electromagnetic 53 can be an electromagnet externally coated with a deformable film in such a way as to allow easy adaptation of the electromagnetic element to any surface.

In this case, the second constraint surface 50 can therefore be defined by the surface of the magnet or by the surface of the film.

In particular, the second electromagnetic element 53 can be a device which can be activated electronically, on command, in such a way as to generate an attractive magnetic field capable of allowing the constraint, by means of the magnetic attraction force generated, between the device 1, in particular the first constraint means 3, and the hull 100.

Therefore, the control means 9 could also be operationally connected to the second electromagnetic element 53 and configured to allow the control of the second electromagnetic element 53.

The second control means 9 are also in this case, preferably electronic control means, with autonomous or non-autonomous power supply, or rather for example external through wiring, configured to allow the operation, on command, of the second electromagnetic element 53.

The control means 9 can also include a simple switch, operable from the outside of the device 1, designed to allow the generation of magnetic force a to lock the first constraint means 3 on the hull 100.

The magnetic force is substantially a force of mutual attraction between the second electromagnetic element 53 and the hull 100.

Furthermore, the control means 9 could include one or more batteries and the latter could be housed within at least the second arm 4 or even within the third arm 7.

The stanchion 10 can, therefore, be constraint to one or more chosen from the arms 2, 4.

Or, the stanchion 10 can be part of one choice between the arms 2, 4. Therefore, the constraint means 3, 5 are configured for integrally constraining the device 1 to the hull 100 in such a way that, when the stanchion 10 is constrained to, or part of, one or more of a choice between the arms 2, 4, the stanchion 10 is constrained to the hull 100.

For example, the stanchion 10 can be a part of the first arm 2, as shown in FIG. 5. Or, again, the stanchion 10 can be part of the third arm 7 and, therefore, a part of the third arm 7 can constitute the stanchion 10, as shown in FIGS. 1-3b.

In these cases, the third arm 7 can provide for the constraint of annular structures, substantially similar to the sliders 60, which are constrained in certain points along the third extension direction 7a and which can include slots for housing the runners. Furthermore, such annular structures could allow the constraint and, therefore, the support of the pressurizing means 8, as shown in FIGS. 2 and 5, or also of the control means 9, as shown in FIG. 10.

Furthermore, the first arm 2 and the second arm 4 can be in one piece and provide a frame on which the stanchion 10 can be constrained. As shown in FIGS. 6-7, the frame can define a hole in which to house and lock a conventional stanchion 10.

The stanchion 10, in particular, can be constrained, thanks to a grain, along any arm 2, 4, 7 in correspondence with any hole. Therefore, the stanchion 10 can be constrained along any point defined along the extension directions 2a, 4a, 7a.

Or, for example in the embodiment of FIGS. 6-7, the first arm 2 and/or the second arm 4 can include one or more first seats 20 and/or second seats 40.

These seats 20, 40 can be included in the device 1 at the same time, for example to increase the versatility of the device 1, or only the first seats 20 or the second seats 40 can be present.

In any case, if present, the first seat 20 allows the stanchion 10 to be constrained in a resolvable way so that it can be moved, or translated, along the first extension direction 2a, while the second seat 40 allows the stanchion 10 to be constrained in a resolvable way so that it can be moved, or translated, along the second extension direction 4a.

Furthermore, the first seat 20 can be one in number or the first arm 2 can include several first seats 20. The first seats 20 can, therefore, be arranged consecutively along the first extension direction 2a or side by side along a perpendicular direction. to the first extension direction 2a to allow the movement on the device 1 of the stanchion 10 perpendicular to the first direction of extension 2a.

The second seat 40 can also be one in number or the second arm 4 can include more second seats 40. The second seats 40 can, therefore, be arranged consecutively along the second extension direction 4a or side by side along a direction perpendicular to the second extension direction 4a to allow the movement on the device 1 of the stanchion 10 perpendicular to the second extension direction 4a.

Naturally, also the third arm 7 could include seats for possible stanchions 10 and also the arms 2, 4, 7, when tubular, could in any case include seats together with the holes or seats suitable for connecting the holes themselves.

Moreover, the device 1 can include several arms 2, 4, 7, for example in pairs, to increase the strength of the overall structure.

In addition, as shown in FIGS. 1-2, the device 1 can include other auxiliary arms and other auxiliary constraint means suitable to allow locking in other additional areas of the hull 100.

Any auxiliary arms and auxiliary constraint means can have similar characteristics respectively to the arms 2, 4, 7 and to the constraint means 3, 5 as previously described. For example, as shown in detail in FIGS. 1-2, the auxiliary arm can correspond to a further third arm 7 and the auxiliary constraint means can correspond to further second constraint means 5.

The operation of the device 1 for attaching a stanchion to a hull of a boat previously described in structural terms is as follows.

Basically, the constraint means 3, 5 are arranged in contact with a part of the hull 100, be it for example a hood 101, a gunwale 102 or a stern platform 103. The constraint means 3, 5 allow, also thanks to the arrangement of the arms 2, 4, 7 to rigidly constrain the device 1 to the hull 100, for example by defining a clamp structure, as in FIGS. 1-2 and 6-7, or by defining a structure which rests stably on the hull 100 as in FIGS. 3a-3b and 5.

The constraint means 3, 5 can therefore be blocked on the hull part 100 using the pressurizing means 8 or the control means 9, or in the embodiment with membranes 31, 51 the third arm 7 can be brought close to the first arm 2, translating it on the second arm 4, in such a way as to trap a part of the hull 100 between the constraint means 3, 5 by friction.

The arms 2, 4 also allow to realize any structural shape by exploiting the connection means 6.

The device 1 for attaching a stanchion to a hull of a boat according to the invention achieves important advantages.

In fact, the device 1 defines an extremely resistant and solid structure, above all, but not only, when made as shown in FIGS. 6-7.

The device 1 introduces in the attachment system redundancies and features such as to guarantee a high locking efficiency and, therefore, a high safety of the guardrail made by exploiting a plurality of devices 1 arranged in succession.

Furthermore, the attachment device is extremely versatile, adaptable to any area of the hull 100 and to any type of boat.

In fact, the device 1, facing the same structure, can be efficiently coupled to any part of a boat hull, as already explained.

The invention is susceptible of variants falling within the scope of the inventive concept defined by the claims.

For example, as previously anticipated, in at least one configuration, the first arm 2 and the second arm 4 could be oriented in such a way that the first extension direction 4a and the second extension direction 7a are parallel to each other. Therefore, the constraint means 3, 5 could comprise respectively a first sucker 32 and a second sucker 52, or a first electromagnetic element 33 and a second electromagnetic element 53, and the device 1 could allow the attachment of a stanchion 10 on one of the arms 2, 4 in such a way as to allow the stanchion to be blocked on any flat or low-curved surface.

In conclusion, the constraint means 3, 5 could be rigidly fastened to the first arm 2 or to the second arm 4 or to the third arm 7, as shown for example in FIG. 11, by means of crank devices suitable for allowing the relative translation between the arm 2, 4, 7 and the constraint means 3, 5. For example, in the device 1 of FIG. 11, the second constraint means 5 are configured to translate with respect to the third arm 7 along a direction perpendicular to the third direction of extension 7a. On the other hand, the constraining means 3, 5 can be rigidly constrained to the crank mechanism in such a way that the first or second constraining surface 30, 50 is perpendicular to the translation direction, or even so that they are inclined with respect to the direction of translation.

In this context, all the details can be replaced by equivalent elements and the materials, shapes and dimensions can be any.

1. A removable guardrail made from a device for attaching a stanchion to a hull of a boat, wherein said device comprises:
a first arm defining a first extension direction,
first constraint means connected to said first arm and defining at least a first constraint surface configured to be arranged in contact with a part of said hull,
a second arm connected to said first arm and defining a second direction of transversal extension, in at least one configuration of use, with respect to said first extension direction, and
second constraint means connected to said second arm and defining at least a second constraint surface configured to be arranged in contact with said same part of said hull,
and
wherein said first and second constraint means are configured to solidly constrain said device to said part of the hull so that, when said stanchion is constrained to, or part of, one or more chosen among said arms, said stanchion is constrained to said hull part.

2. The guardrail according to claim 1, wherein said first constraint means is constraint in a compliant way to said first arm and said first constraint surface is inclinable with respect to said first extension direction.

3. The guardrail according to claim 1, wherein said device comprises first connection means configured to constrain in a compliant way said first arm to said second arm in such a way that said extension direction are mutually skewed and said arms are rotatable between each other.

4. The guardrail according to claim 1, wherein said device comprises a third arm defining a third extension direction transversal, in at least one configuration of use, with respect to said second extension direction and configured to mutually connect said second arm and said second constraint means.

5. The guardrail according to claim 4, wherein said third arm is constrained in a compliant way to said second arm in such a way as to be able to translate on command along said second extension direction.

6. The guardrail according to claim 4, wherein said second constraint means is constrained in a compliant way to said third arm or said second arm in such a way that said second constraint surface is inclinable with respect to said third extension direction or said second extension direction.

7. The guardrail according to claim 4, wherein part of said third arm constitutes said stanchions.

8. The guardrail according to claim 1, wherein at least one of said constraint means comprises an elastomeric membrane and at least one of said first constraint surface and said second constraint surface is made from said membrane.

9. The guardrail according to claim 1, wherein at least one of said constraint means comprises an elastomeric sucker and at least one of said first constraint surface and said second constraint surface is made from edges of said sucker.

10. The guardrail according to claim 9, wherein said device comprises pressurizing means operatively connected to one or more said suckers and configured to depressurize on command a space between said sucker and said hull in such a way as to lock said sucker on said hull.

11. The guardrail according to claim 1, wherein at least one of said constraint means comprises an electromagnetic element and at least one of said first constraint surface and said second constraint surface is made by said electromagnetic element.

12. The guardrail according to claim 10, wherein said device comprises control means operatively connected to one or more said electromagnetic elements and configured to allow the operation, on command, of said electromagnetic elements so as to realize a magnetic attraction force between said electromagnetic elements and said hull.

13. The guardrail according to claim 2, wherein said first arm and said second arm are in one piece and form a frame on which a stanchion can be fixed.

14. The guardrail according to claim 2, wherein said device comprises a third arm defining a third extension direction transversal, in at least one configuration of use, with respect to said second extension direction and configured to mutually connect said second arm and said second constraint means.

15. The guardrail according to claim 5, wherein said second constraint means are constrained in a compliant way to said third arm or said second arm in such a way that said second constraint surface is inclinable with respect to said third extension direction or said second extension direction.

16. The guardrail according to claim 5, wherein part of said third arm constitutes said stanchions.

17. The guardrail according to claim 2, wherein at least one of said constraint means comprises an elastomeric membrane and at least one of said first constraint surface and said second constraint surface is made from said membrane.
